(19) United States
(12) Patent Application Publication
(10) Pub. No.: US 2019/0008174 A1
(43) Pub. Date: Jan. 10, 2019

(54) MEAT PROCESSING METHODS

(71) Applicant: Cal Poly Corporation, San Luis Obispo, CA (US)

(72) Inventors: Iksoon Kang, San Luis Obispo, CA (US); Sean P. Hurley, San Luis Obispo, CA (US)

(21) Appl. No.: 16/017,349

(22) Filed: Jun. 25, 2018

Related U.S. Application Data
(60) Provisional application No. 62/529,537, filed on Jul. 7, 2017.

(51) Int. Cl. A23B 4/09; A01N 59/08; A23B 4/023

(52) U.S. Cl. CPC A23B 4/09; A23V 2002/00; A23B 4/023; A01N 59/08

(57) ABSTRACT

The present invention relates to increase processing efficiency, improve product quality, enhances product safety, improves sensory attributes, and meets customer demands. Due to the rapid carcass chilling in a given water consumption, this invention also related to sustainable agriculture, particularly environmentally-friendly food preparation, particularly resource-saving meat processing, particularly water-efficient and energy-efficient meat processing. The present invention provides, inter alia, methods to chill an animal carcass so as to improve tenderness in the finished fresh product, comprising: immersing an animal carcass in at least one saltwater solution, wherein the percentage of salt in the water is in the range of from about 1% salt/water to about 10% salt/water, and wherein the temperature of the saltwater solution is in the range of from about −0.6° C. to about −6.0° C.; and chilling the animal carcass.

### REFERENCE TO RELATED APPLICATION

This application claims priority to previously filed and co-pending provisional application U.S. Ser. No. 62/529,537, filed Jul. 7, 2017, the contents of which are incorporated herein by reference.

### FIELD OF THE INVENTION

The present invention relates to animal processing technology, particularly increases processing efficiency, particularly enhances product safety, and particularly improves meat tenderness that co-incidentally increases water-efficient and energy-efficient poultry processing.

### BACKGROUND

Innovative food manufacturing technologies are highly desirable to improve processing efficiency, product quality, and safety, not only for meat processors but also for consumers. According to the US Poultry and Egg Association (2015), approximately 374,000 people are employed in poultry processing plants nationwide, and additional 1.4 million jobs are generated in supplier and ancillary industries, including feed mills, hatcheries, distribution centers, and corporate headquarters. Currently, about 232 million turkeys and 8.8 billion broilers are processed annually in the United States (USDA NASS, 2016).

Further, Salmonella, Campylobacter and pathogenic Escherichia coli account for more than 99% of total bacterial foodborne illnesses in the U.S. (USDA ERS 2000). Poultry, the most consumed meat in the U.S., is an excellent vehicle for those pathogens especially Salmonella and Campylobacter (Capita, R., M. Prieto, and C. Alonso-Calleja. 2004. Sampling methods for microbiological analysis of red meat and poultry carcasses. Journal of Food Protection 67:1303-1308

Fresh meats products are a challenge to produce in a warm condition, and freshly-slaughtered animals must be chilled rapidly, without freezing, so as to suppress bacterial populations and preserve desirable sensory qualities. The meat industry has devised various quick-chilling strategies, all of which require energy and water inputs. As energy and water costs continue to increase, the necessity of finding alternative, more efficient and sustainable meat processing strategies are needed. Efficiencies in meat processing strategies, such as those described herein, benefit processors, consumers, and the environment.

### SUMMARY

The present methods provide for immersing an animal carcass in at least one saltwater solution, where the salt content of the water is from about 1% (w/v) salt/water to about 10% (w/v) salt/water and providing the temperature of the saltwater solution is from about −0.6° C. to about −6.0° C. Processes provided here, are able in embodiments to reduce contamination from microbial sources such as bacteria, improve tenderness of the resulting meat product, and have 1% or less, or no additional salt content in the resulting meat product, and enhance processing efficiency that decreases cost, water usage, waste water output, time and energy necessary for processing meat carcasses.

### BRIEF DESCRIPTION OF THE DRAWINGS

FIG. 1 is a graph showing effects of broiler chilling temperature and salt content on shear force of broiler breast fillets after chilling in water (ice slurry) or brine solutions.

FIG. 2 is a graph showing effects of broiler chilling temperature and salt content on shear force of broiler breast fillets after chilling in water or brine solutions. Means with unlike superscripts are different (P<0.05); where pre-chill is indicated, in the last three bars of the graph, the carcass was chilled with pre-chilling at 0% NaCl at 14° C. (a) or 0.5° C. (b); where chilling is indicated, the carcass was chilled with no pre chilling.

FIG. 3 is a graph showing temperature change profiles of broiler carcasses during chilling in water or brine solutions. For 0% NaCl/0.5° C., the carcass was chilled in an ice slurry (0% NaCl) at 0.5° C.; for 1% NaCl/−0.6° C., the carcass was chilled in 1% NaCl at −0.6° C.; for 2% NaCl/−1.2° C., the carcass was chilled in 2% NaCl at −1.2° C.; for 3% NaCl/−1.8° C., the carcass was chilled in 3% NaCl at −1.8° C.

FIG. 4 is a graph showing effects of broiler chilling temperature and salt content on shear force of broiler breast fillets after chilling in water or brine solutions. Means with unlike superscripts are different (P<0.5). The same chilling methods were used as described in FIG. 3.

FIG. 5 is a graph showing temperature change profiles of broiler carcasses during chilling in water or brine solutions. For 0% NaCl/0.5° C., the carcass was chilled in an ice slurry (0% NaCl) at 0.5° C.; for 3% NaCl/−1.8° C., the carcass was chilled in 3% NaCl at −1.8° C.; for 4% NaCl/−2.4° C., the carcass was chilled in 4% NaCl at −2.4° C.

FIG. 6 is a graph showing effects of broiler chilling temperature and salt content on shear force of broiler breast fillets after chilling in water or brine solutions. Means with unlike superscripts are different (P<0.05). The same shilling methods were used as in FIG. 5.

FIG. 7 is a graph showing temperature change profiles of turkey carcasses during chilling in water or brine solutions. For the solutions indicated: 0% NaCl/0.5° C. chilled carcasses in an ice slurry (0% NaCl) at 0.5° C.; 4% NaCl/−2.4 chilled carcasses in 1% NaCl at −2.4° C.; and 8% NaCl/−5.08° C. chilled carcasses in 2% NaCl at −5.08° C.

### DETAILED DESCRIPTION

Following immersion of carcasses in sub-zero saltwater, unexpected benefits were obtained in certain embodiments as follow; chilling for shorter periods of time and obtaining the disclosed improvements, improved meat tenderness, reduced bacterial population, maintenance of the same salt content as control meat, use of less water, and reduction of costs of meat processing. The processes are described below in more detail and are carried out on an animal that has been slaughtered. In a preferred embodiment, the animal is placed in the chilled salt water immediately after being slaughtered, before the time in which rigor mortis develops or when the meat is still in pre-rigor condition. Allowance may also be made after slaughter for optional processing such as stunning, bleeding, scalding, dehairing, torching, evisceration, USDA inspection, washing and pre-chilling. The time involved prior to immersion in the saline water will be dependent upon these optional steps employed and the setup of the processing facility and efficiency. By way of example, without limitation, poultry and fish in an embodiment can be immersed in the chilled saltwater 15 to 25 minutes post mortem, pork and lamb immersed 30 to 45 minutes postmortem and beef 30 to 60 minutes post mortem.

The present processes provide, inter alia, methods to chill an animal carcass so as to improve tenderness in the finished fresh product, comprising:

immersing a freshly-slaughtered and eviscerated animal carcass in at least one saltwater solution,

wherein the percentage of salt in the water is in the range of from about 1% salt/water to about 10% salt/water, and

wherein the temperature of the saltwater solution is in the range of from about −0.6° C. to about −6.0° C.; and

chilling the animal carcass and enhancing tenderness in the finished product.

Chilling of carcasses in a sub-zero saline solution improves processing efficiency, meat quality, product safety, sensory attributes, and overall processing cost. An embodiment provides that use of the subzero chilling solution provides increased chilling efficiency more than above-zero or warmer temperatures. For example, using the subzero chilling solution here, and chilling for 45 to 60 minutes is more efficient than traditional steps such as chilling for 80 to 140 minutes in an ice slurry of 4° C.; or where using two chilling steps, such as pre-chilling at 5 to 20° C. followed by post-chilling at 1 to 5° C. for total chilling time of 60 to 150 minutes. Thus, with the present process, less energy is used and more carcasses can be processed in the same amount of time. In an embodiment, the time for chilling the animal as a part of meat processing is reduced. An embodiment reduces the time by at least about 10, 15, 20, 25, 30, 35, 40, 45, 50, 55, 60, 65, 70, 75, 80, 85, 90, 95, 100, 105, 110, 115, 120, 125, 130, minutes to 135 minutes or more; and in further embodiments reduces the time by at least 5%, 10%, 15%, 20%, 25%, 30%, 35%, 40%, 45%, 50%, 55%, 60%, 65%, 70%, 75%, 80%, 85%, 90%, or more.

By increasing the number of carcasses per gallon of chilling water, processors can reduce processing costs through higher chilling rate, lower water consumption, lower wastewater output, and more efficient energy usage. Furthermore, sub-zero chilling reduces bacterial attachments on carcasses due to skin shrinkage and lower bacterial activity than skin swelling and higher bacterial movement in water at ≥1° C.

The present invention provides methods to chill an animal carcass so as to improve tenderness in the finished fresh product, comprising:

immersing an animal carcass in at least one saltwater solution,

wherein the percentage of salt in the water is in the range of from about 1% (w/v) salt/water to about 10% (w/v) salt/water, and

wherein the temperature of the saltwater solution is in the range of from about −0.6° C. to about −6.0° C.; and

chilling the animal carcass and encouraging tenderness in the finished product.

An embodiment provides for adding salt to the chilling water as described, wherein the addition of salt does not increase the salt content of the meat after chilling or increases it 1% or less.

Further, an embodiment provides for chilling the carcass more quickly using the methods described here. In an embodiment the animal is taken from body temperature following slaughter (body temperature being the temperature of the animal at the time of slaughter, generally about 40° C., and some birds having temperature about 40.6° C.) to at or less than 5° C. using the subzero temperatures described here of −0.6° C. to −6.0° C. The amount of time will vary depending on the size of the carcass but can be reduced compared to a process not using salt and the temperatures by about 5%, 10%, 20%, 25%, 30%, 35%, 40%, 45%, 50%, 55%, 60%, 65%, 70%, 75%, 80%, 90%, 95% or more and amounts in-between. Preferred embodiments provide the time of cooling compared to a process not using salt and the subzero temperatures described here is reduced by 15% to at least 50%, and in other embodiments 15% to 25%. For example, the time to reduce the temperature of chicken from body temperature to 5° C. or less, in an example to about 4.4° C. to 4.7° C. is about 22% and to reduce the temperature of a turkey carcass from about 43° C. to about 4.8° C. can be reduced by 46% to about 58%. Embodiments provide the animal is taken from body temperature to about 4.4° C. and then the chilling process stopped. Still further embodiments provide total chilling time is 1.5 to 2.0 hours.

The methods described here also provide for increased tenderness as measured by shear force is improved, where the shear force is reduced compared to a process that does not use salt and subzero temperatures of −0.6° C. to −1.5° C. Additional embodiments provide for decreasing bacteria on the carcass, including decrease in bacterial activity and/or decrease in attachment of bacteria to skin of the carcass when using salt and the subzero temperatures as described here.

When referring to temperatures or percent decrease of “about” a certain number is meant the variation typically associated with such measurements and can be, for example, plus or minus 1, 2 or 3 degrees or plus or minus 1 to 5% time.

It has been found that despite the exposure to the subzero cold temperatures with the present process, there is not undue cold shortening that increases force shear, reduces sarcomere length, and instead produces a tender meat product.

Any animal that is slaughtered for meat may be used with the present processes. By way of example without limitation, the methods may be used where the animal is selected from the group consisting of: ungulate; fowl; and fish; where the animal is cow; pig; elk; bison; deer; sheep; goat; turkey; chicken; salmon; tuna; and cod.

Also provided are methods to process poultry such as chicken so as to improve tenderness in the finished fresh product, the method comprising:

immersing poultry such as chicken in at least one saltwater solution,

wherein the percentage of salt in the saltwater is in the range of from about 1% salt/water to about 10% salt/water, and

wherein the temperature of the saltwater solution is in the range of from about −0.6° C. to about −6.0° C.; and

chilling the chicken and improving tenderness in the finished fresh product.

Also provided are methods to reduce bacterial population during meat production, comprising:

immersing a freshly-slaughtered and eviscerated animal carcass in at least one saltwater solution,

wherein the percentage of salt in the water is in the range of from about 1% (w/v) salt/water to about 10% (w/v) salt/water, and

wherein the temperature of the saltwater solution is in the range of from about −0.6° C. to about −6.0° C.; and

chilling the animal carcass and reducing bacterial population.

Also provided are methods to produce a meat product, wherein the salt content is increased has 1% or less, has less than 0.16%, or is not increased, comprising:

immersing an animal carcass in at least one saltwater solution,

wherein the percentage of salt in the water is in the range of from about 1% (w/v) salt/water to about 10% (w/v) salt/water, and

wherein the temperature of the saltwater solution is in the range of from about −0.6° C. to about −6.0° C.; and

chilling the animal carcass and producing a meat product in which there is 1% or less, less than 0.16% or no increase in salt content and any increase in salt content in the chilled carcasses can be removed by further processing. Current methods typically do not add salt to the chilling water, where here salt is added. The inventors have found that salt in the water is not absorbed by the muscle of the carcasses during chilling. Some salt solution can be trapped between the skin and meat, but can be eliminated during further processing, such as when cutting, deboning meat, or de-skinning for example.

Also provided are methods to reduce potable water use during meat production, comprising:

immersing an animal carcass in at least one saltwater solution,

wherein the percentage of salt in the water is in the range of from about 1% (w/v) salt/water to about 10% (w/v) salt/water, and

wherein the temperature of the saltwater solution is in the range of from about −0.6° C. to about −6.0° C.; and

chilling the animal carcass and reducing potable water used.

Also provided are methods to reduce wastewater output during meat production, comprising:

immersing an animal carcass in at least one saltwater solution,

wherein the percentage of salt in the water is in the range of from about 1% (w/v) salt/water to about 10% (w/v) salt/water, and

wherein the temperature of the saltwater solution is in the range of from about −0.6° C. to about −6.0° C.; and

chilling the animal carcass and reducing wastewater output.

Also provided are methods to reduce the overall time for processing during meat production, comprising:

immersing an animal carcass in at least one saltwater solution,

wherein the percentage of salt in the water is in the range of from about 1% (w/v) salt/water to about 10% (w/v) salt/water, and

wherein the temperature of the saltwater solution is in the range of from about −0.6° C. to about −6.0° C.; and

chilling the animal carcass and reducing time for processing.

Also provided are methods to reduce energy use during meat production, comprising:

immersing an animal carcass in at least one saltwater solution,

wherein the percentage of salt in the water is in the range of from about 1% (w/v) salt/water to about 10% (w/v) salt/water, and

wherein the temperature of the saltwater solution is in the range of from about −0.6° C. to about −6.0° C.; and

chilling the animal carcass and reducing energy use.

Also provided are methods to reduce processing cost of meat processing, comprising:

immersing an animal carcass in at least one saltwater solution,

wherein the percentage of salt in the water is in the range of from about 1% (w/v) salt/water to about 10% (w/v) salt/water, and

wherein the temperature of the saltwater solution is in the range of from about −0.6° C. to about −6.0° C.; and

chilling the animal carcass and reducing processing cost.

Less water is used in the present process than in traditional chilled water processes. Here, chilling efficiency results from cold temperatures. By way of example, without limitation, if it is possible to chill ten carcasses such as poultry per hour in subzero cold water instead of five poultry per hours in an ice slurry, it can allow for reducing chilling water by 50%. The reduction in water used and costs can be 10%, 20%, 30%, 40%, 50% 60%, 70%, 80%, 90% or more in an embodiment.

Embodiments provided herein include any methods as described, wherein the percentage of salt in the saltwater is in a range selected from the group of: about 1% (w/v) salt/water to about 10% (w/v) salt/water; 1% (w/v) salt/water to about 9% (w/v) salt/water; 1% (w/v) salt/water to about 8% (w/v) salt/water; 1% (w/v) salt/water to about 7% (w/v) salt/water; 1% (w/v) salt/water to about 6% (w/v) salt/water; 1% (w/v) salt/water to about 5% (w/v) salt/water; 1% (w/v) salt/water to about 4% (w/v) salt/water; 1% (w/v) salt/water to about 3% (w/v) salt/water; and 1% (w/v) salt/water to about 2% (w/v) salt/water. The percentage of salt in the saltwater in an embodiment can be about 1%, 2%, 3%, 4%, 5%, 6%, 7%, 8%, 9% or 10% or amounts in-between.

Embodiments provided herein include any methods as described, wherein the temperature of the saltwater solutions is in a range selected from the group of: from about −0.6° C. to about −6.0° C.; from about −1.0° C. to about −5.0° C.; from about −2.5° C. to about −5.0° C.; from about −2.5° C. to about −4.0° C.; and from about −3.0° C. to about −4.0° C. The temperature of the saltwater solution in an embodiment may be about −1.5° C., −2° C., −3° C., −4° C., −5° C., −6° C. or amounts in-between.

Embodiments provided herein include any methods as described, wherein the step b) is conducted for about 0.5 hour to about 4 hours.

Embodiments provided herein include any methods as described, wherein the step b) is conducted for about 1 hour to about 3 hours.

Embodiments provided herein include any methods as described, wherein the step b) is conducted for about 1.5 hour to about 2.5 hours.

Embodiments provided herein include any methods as described, wherein the step b) is conducted for about 2 hours.

Embodiments provided include where step b) is conducted for about 0.5, 1, 2, 3, 4, hours or amounts in-between.

Embodiments provided herein include any methods as described, wherein step b) is conducted such that the finished product has a shear force (N) of from about 6 to 11.

Embodiments provided herein include any methods as described, wherein step b) is conducted such that the finished product has a shear force (N) of from about 7.2 to about 8.5.

Embodiments provide the methods wherein step b) is conducted such that the product has a shear force (N) of about 6, 7, 8, 9, 10, 11 or amounts in-between.

Embodiments provided herein include any methods as described, which result in no significant absorption of saltwater during processing compared to similar processing in water alone.

Embodiments provided herein include any methods as described, which result in no significant chilling yield increase compared to similar processing in water alone. Chilling yield refers to the weight of meat that results at the end of the chilling process.

Embodiments provided herein include any methods as described, which result in no significant salt content increase compared to similar processing in water alone.

Embodiments provided herein include any methods as described, which result in no significant cooking yield increase compared to similar processing in water alone.

Embodiments provided herein include any methods as described, which result in no significant pH change compared to similar processing in water alone.

Embodiments provided herein include significantly reduced R-value in 3% NaCl/−1.8° C. and 4% NaCl/−2.4° C. compared to similar processing in water alone.

Also provided is the invention as shown as claimed herein.

The present processes may be conducted as steps of a larger meat processing strategy characterized by a serious of killing and processing steps. Other optional steps which may be employed in a meat processing strategy include a hanging step before or after killing, bleeding, hot-water immersing (scalding) and/or skinning or plucking, or hollowing/eviscerating. A chilling step (via the methods described herein) is performed either in succession or simultaneously. Further optional steps may include a succeeding cutting-up/dispensing/packaging process, distribution to end users, cooking, and eating. A copy of a book chapter on poultry processing, written by the inventor and his co-author, is included as an appendix herein as further background information. Kang et al. (2016) “Enhancing texture and tenderness in poultry meat” Vol. 1, pp. 291-314 Achieving sustainable production of poultry meat, Ricke Edit., Burleigh Dodds Science Publishing Limited.

In modern poultry processing plants, typically birds are first slaughtered and then eviscerated.

The eviscerated carcasses are in a typical current process at a temperature of 38° C. or higher and must be chilled rapidly to avoid the proliferation of bacteria. The chilling of the eviscerated carcasses is typically carried out in a chiller, which comprises a chilled water (ice slurry) bath. The eviscerated carcasses are maintained in the chiller for a sufficient residence time to chill them to a temperature of 4.4° C. or only slightly above the freezing point of water. Counter flow poultry chillers with “bird moving auger” are commonly used in poultry processing (U.S. Pat. Nos. 6,089,037 and 6,397,622). Such chillers can be in excess of 31 meters (100 feet) in length in order to obtain sufficient residence time to chill the poultry carcasses to the desired final temperature. The residence time depends on the rate of heat transfer from the carcasses to the chilling water and is limited by the rate of heat transfer from the interior to the surface of the poultry carcass. In addition, pre-chillers and post-chillers may also be used to separate carcasses in the first-chiller (dirty-tank) from the second-chiller (clean-tank) that can extend the chilling time of the poultry carcasses. Examples of such devices and processes include that described at U.S. Pat. No. 4,860,554 Counter-flow poultry chiller; US Publication No. 20080141685 Method, Apparatus & Cooling Element for Cooling Carcass; WO 1999021429 Method and system for chilling of carcass parts after slaughtering; U.S. Pat. No. 8,376,815 Method and Apparatus for Electrical Stimulation of Meat; US U.S. Pat. No. 4,667,370 Salt-water butchering process for poultry and other fowl.

Chillers therefore have a large “footprint” in a poultry processing plant. With the present methods in an embodiment one can reduce this footprint and reduce the processing time, both for the sake of efficiency and to reduce the potential for bacterial contamination.

In another embodiment, a pre-chill process may be used with the chilling process described here.

Such a pre-chill process can in an embodiment comprise submerging the carcass in at least one water bath having a temperature of about 0° C. to about 20° C. and can be conducted for about five to 30 minutes. Another embodiment provides the pre-chilling process can be conducted

Further description and embodiments are found elsewhere in the specification, including the claims and drawings.

### Definitions

Before the present compositions and methods are disclosed and described, it is to be understood that the terminology used herein is for the purpose of describing particular embodiments only and is not intended to be limiting. It must be noted that, as used in the specification and the appended claims, the singular forms “a,” “an” and “the” include plural referents unless the context clearly dictates otherwise.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are explicitly contemplated.

As used herein, the term “about” refers to +/−10%.

“Poultry” includes any fowl or bird, and includes, and by way of example without limitation, chickens, turkeys, geese, capon, cornish hens, squab, ducks, guinea, fowl and pheasants.

“Carcass” it is intended to cover whole slaughtered animals (such as a chicken) as well as parts. In an embodiment, the carcass is that of an animal that has been slaughtered.

(w/v) means weight to volume. For example, grams to liters. When expressed as a percentage, the ratio is calculated by multiplying ratio of weight/volume by 100. For example, 1% saltwater could be produced by dissolving 10 grams of salt in 1 liter (1000 mL) of water. (10/1000×100=1)

The following examples are presented in order to more fully illustrate some embodiments of the invention. They should, in no way be construed, however, as limiting the scope of the invention. References cited herein are incorporated herein by reference.

### Examples

Materials.

Broiler carcasses were obtained from the Meat Processing Center (Experiment I and III) at California Polytechnic State University (Cal Poly, San Luis Obispo, Calif.) and from a local poultry processing plant (Experiment II and IV). Turkey carcasses were obtained from a local poultry processing center (Experiment V).

Brine Chilling Solution and Brine Ice Preparation.

Prior to processing, both brine solution and brine ice were prepared. Salt (NaCl) was added and completely dissolved using tap water for 1, 2, 3, 4, or 8% NaCl brine solutions by weight, which were then placed in individual 20-gallon containers for carcass chilling. In addition, the solutions were placed into one-quart zip-seal bags for additional brine ice according to the target NaCl concentration. Both 20-gallon containers and zip-seal bags were placed overnight in a freezer room at −29° C.

Methods.

pH.

The pH value of breast muscle was measured with a pH electrode (model 13 620 631, Fisher Scientific Inc., Houston, Tex.) attached to a pH meter (Accumet AR15, Fisher Scientific Inc., Pittsburgh, Pa.) using the iodoacetate method of Sams and Jancky (1986).

R-Value.

R-value (ratio of inosine:adenosine) was assessed as an indicator of adenosine triphosphate (ATP) depletion in the muscle using the method of Thompson et al. (1987).

Sarcomere Length.

Sarcomere length was evaluated for the status of muscle contraction using a laser diffraction method (Cross et al., 1980).

Cooking Yield and Shear Force.

For the evaluation of cooking yield and shear force, the method of Jeong et al. (2011) was used. Briefly, 12 left fillets (aged 24 h) per treatment were individually weighed, placed on stainless trays on a stainless-steel rack, and covered with foil. The fillets were cooked to an internal temperature of 76.7° C. in a preheated convection oven (Bloccos-101/AA, The G. S. Blodgett Corp., Burlington, Vt.) at 177° C. following USDA-Food Safety and Inspection Service (2001) guidelines. Temperature was monitored with 2 thermocouples inserted to the thickest parts of 2 breast samples on 2 trays. After cooking, the fillets were removed from the trays, individually wrapped with foil, and stored overnight at 3° C. in plastic bags. The following day, the cooked breasts were brought to room temperature and weighed again to determine cooking yield. Cooking yield was calculated by the following equation: (cooked breast weight)/(raw breast weight)×100. For shear force measurement, fillets were placed on stainless trays on a stainless-steel rack, covered with foil, and cooked to an internal temperature of 76.7° C. in a convection oven (Bloccos-101/AA, The G.S. Blodgett Corp., Burlington, Vt.), using the method of USDA-Food Safety and Inspection Service (2001) guidelines. Shear force was determined according to the razor-blade method described by Cavitt et al. (2004). A texture analyzer (TAHDi, Texture Technologies Corp., Scarsdale, N.Y.) was calibrated with a 5-kg load cell. The razor blade (height, 24 mm; width, 8 mm) was set at 10 mm/s, and the test was triggered by a 10-g contact force. The shear force value (N) was calculated as the maximum force recorded during the shear. Two shear force measurements per breast fillet were made.

Statistical Analysis.

All experiments were conducted for 3 times. Data were evaluated by one-way ANOVA, using PASW 18 statistic program and a completely randomized design. A post-hoc analysis was performed using Duncan's multiple range test to evaluate difference among treatments (P<0.05; SPSS, 2011).

### Example I and II. Carcass Chilling Using Brine Solution at 0, 4 and 8%

For Experiment I, a total of 15 broilers (Ross 708, approximately 45 days old) were used for three chilling treatments (5 birds/treatment for one replication), using one control (0% NaCl/0.5° C.) and two sub-zero saline (4% NaCl/−2.41° C. and 8% NaCl/−5.08° C.) solutions, without pre-chilling, whereas a total of 72 broilers (Ross 708, approximately 45 days old) were used in Experiment II for chilling with pre-chilling (4 birds/treatment for three replications). As a result, eviscerated broiler carcasses were chilled in Experiment I using one of three chilling treatments (0% NaCl/0.5° C., 4% NaCl/−2.41° C., and 8% NaCl/−5.08° C.) with mechanical agitator (VS-500, Grovhac Inc., Brookfield, Wis.). Broiler carcasses in Experiment II were chilled using the same chilling treatments (0% NaCl/0.5° C., 4% NaCl/−2.41° C. and 8% NaCl/−5.08° C.), except using pre-chilling in 0% NaCl/14° C. or 0% NaCl/0.5° C.

Prior to chilling, birds in Experiment I were traditionally processed after transportation of feed-withdrawn birds (for 8 h) from the Poultry Unit to the Meat Processing Center at California Polytechnic State University (Cal Poly, San Luis Obispo). Each bird was shackled, electrically stunned for 3 s (40 mA, 60 Hz, 110 V), and bled for 90 s by severing both the carotid artery and jugular vein on one side of the neck. After bleeding, birds were subjected to scalding water (56° C.) for 120 s, defeathered in a rotary drum picker (SP30 Ashley Sure-Pick, Ashley Machine Inc., Greensburg, Ind.) for 20 s, manually eviscerated, and washed. Resulting carcasses (4.8 pounds average weight) were hung on a shackle line and tagged on wing. For Experiment II, broiler carcasses (4.2 pounds average weight) were obtained from the broiler processing line at Foster Farms (Livingston, Calif.) and chilled in the plant using the same 20-gallon containers as used in Experiment I.

Before chilling, one medium carcass per chilling solution was selected for monitoring the internal breast temperature every 5 min until the carcass temperature reached ˜4° C. per USDA-FSIS regulations, using a digital thermometer logger (ThermaData Thermocouple Logger KTC, ThermoWorks, American Fork, Utah). During chilling, either control or brine ice was added to maintain target solution temperatures. After chilling, carcasses were hung on a shackle and placed in the poultry cooler (1.1° C.) to reach 3 h post mortem.

Results.

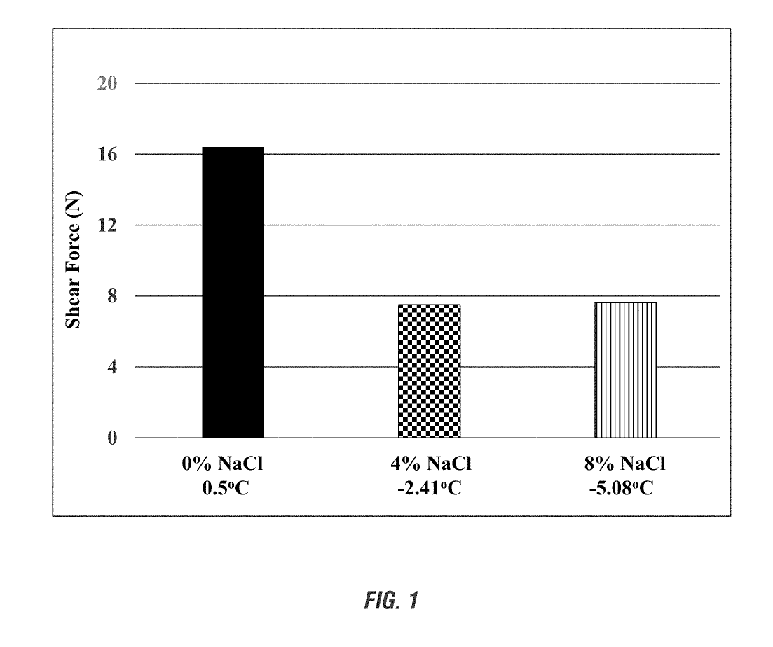

In Experiment I, the breast fillets in sub-zero saline solutions showed a lower shear force than the control fillets in 0% NaCl/0.5° C., regardless of salt content (FIG. 1).

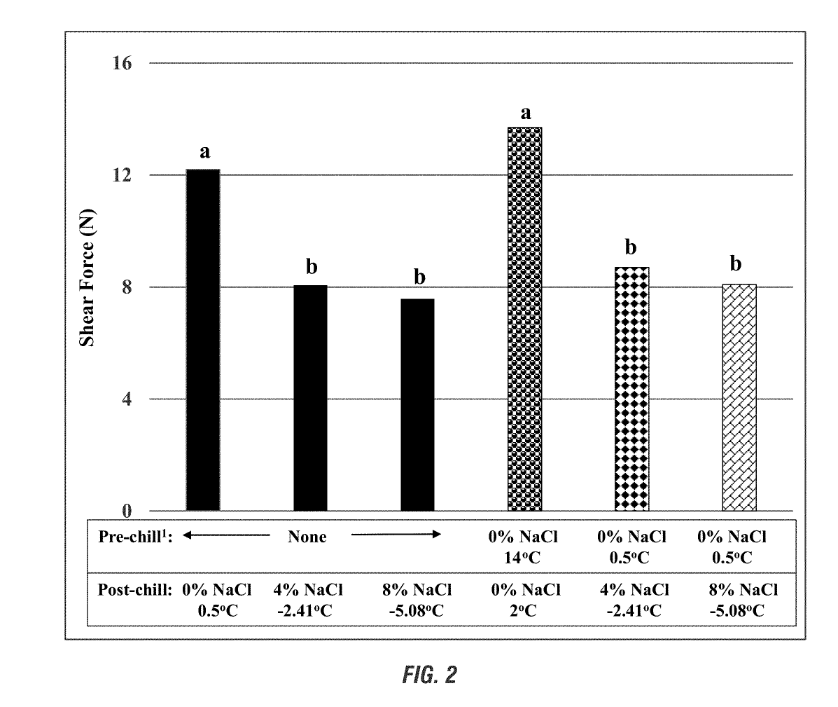

In Experiment II, the breast fillets from broiler carcasses in saline solutions significantly improved tenderness more than in 0% NaCl solution (P<0.05) by reducing the shear force (12-14 N) to the level of 8.1 to 8.7 N, with no difference between 4% NaCl/−2.41° C. (8.1-8.7 N) and 8% NaCl/−5.08° C. (7.6 to 8.1 N) solutions, regardless of the pre-chilling condition (FIG. 2). The lower shear force of breast fillets in saline solutions indicates that the muscle is more tenderized than the muscle in 0% NaCl. Sams and Janky (1986) reported that brine chilling of hot-boned fillets, using pre-chilling (30 min at 21° C.) and post-chilling (30 min at 1° C.), improved tenderness of hot-boned fillets to the same level of chill-boned fillets that were harvested after carcass chilling. Evaluating chilling speed, Dunn et al. (1995) reported that faster chilling eliminated the risk of adverse rigor shortening (or heat shortening) and textural variability.

### Example III. Carcass Chilling Using Brine Solution at 0, 1, 2 and 3%

Broiler Carcass Processing.

A total of 48 broilers (Ross 708, approximately 45 days old) were used for four chilling treatments (4 birds/treatment for 3 replications) using one control (0% NaCl/0.5° C.) and three sub-zero (1% NaCl/−0.6° C., 2% NaCl/−1.2° C., and 3% NaCl/−1.8° C.) solutions. After 12-hour feed withdrawal, birds were cooped and transported from the Cal Poly Poultry Unit to the Meat Processing Center. Each bird was shackled, electrically stunned for 3 s (40 mA, 60 Hz, 110 V) and bled for 90 seconds by severing both the carotid artery and jugular vein on one side of the neck. After bleeding, birds were subjected to scalding 56° C. for 120 seconds, defeathered in a rotary drum picker (SP38SS Automatic Pickers, Brower Equipment, Houghton, Iowa) for 25 s, manually eviscerated, and washed. Resulting carcasses were hung on shackle, allowed for 5 minutes drain, and weighed for pre-chill weights after tagging on wing. The resulting carcasses were then immediately chilled.

Broiler Carcass Chilling.

After evisceration and washing, broiler carcasses were tagged and chilled by submersing in one of four chilling solutions while agitating mechanically: 1) 0% NaCl (ice slurry) at 0.5° C., 2) 1% NaCl brine solution at −0.6° C., 3) 2% NaCl brine solution at −1.2° C., and 4) 3% NaCl brine solution at −1.8° C. Before chilling, one carcass (a medium weight) per chilling was selected for monitoring the internal breast temperature during chilling (every 5 min), using a digital thermometer logger (800024, Sper Scientific Ltd., Scottsdale, Ariz.) until the carcass temperature reached ˜4° C. During chilling, sufficient ice or brine ice was added to maintain the target solution temperatures. After chilling, carcasses were hung on shackle, allowed for 5 min drain, and weighed for post-chill weight gain.

Results.

Carcass Chilling Time.

The internal temperature of eviscerated or prior-chilling carcasses was 40° C. that was continuously reduced to 4.4˜4.7° C. during chilling, with average chilling times for 115, 100, 95, and 90 min in water control at 0.5° C. and three brine solutions (1% NaCl/−0.6° C., 2% NaCl/−1.2° C., and 3% NaCl/−1.8° C.), respectively (FIG. 1). Specifics of each condition are listed below Table 1. These results indicated that 3% NaCl significantly reduced the chilling time by 25 min (or 22%) compare to the water control, with intermediated reduction (13-17%) seen for other NaCl solutions.

Carcass Chilling Yield, Fillet Salt Content, and Fillet Cooking Yield.

Table 1 is a Table showing chilling yield of broiler carcass and pH and R-value of fillet after chilling in water or brine solutions as well as salt content and cooking yield of fillet after cooking. After chilling, broiler carcasses were evaluated for a weight gain that showed 2-3% increase with no significant difference, regardless of chilling method (Table 1).

TABLE 1
Evaluation¹ of carcass chilling yield and breast fillet salt content, pH, R-value, sarcomere length
and cooking yield (±SEM) after chilling broiler carcasses² in three different chilling solutions

| | | | | |
|---|---|---|---|---|
| Chilling | 0% NaCl/0.5^{°} C. | 1% NaCl/−0.6° C. | 2% NaCl/−1.2° C | 3% NaCl/−1.8° C. |

Raw fillets

| | | | | |
|---|---|---|---|---|
| Chilling yield (%) | 102.3^{a} ± 0.60 | 101.9^{a} ± 0.52 | 102.0^{a} ± 0.39 | 103.3^{a} ± 1.31 |
| pH | 6.03^{a} ± 0.14 | 5.83^{a} ± 0.07 | 5.80^{a} ± 0.14 | 5.98^{a} ± 0.07 |
| R-value | 1.24^{a} ± 0.15 | 1.25^{a} ± 0.06 | 1.27^{a} ± 0.1 | 1.29^{a} ± 0.02 |
| Sarcomere length | 1.29^{a} ± 0.05 | 1.26^{a} ± 0.05 | 1.25^{a} ± 0.03 | 1.36^{a} ± 0.29 |

Cooked fillets

| | | | | |
|---|---|---|---|---|
| Cooking yield (%) | 73.4^{a} ± 2.37 | 71.5^{a} ± 0.38 | 72.9^{a} ± 1.48 | 73.4^{a} ± 0.72 |
| Salt content (%) | 0.056^{a} ± 0.01 | 0.060^{a} ± 0.01 | 0.058^{a} ± 0.05 | 0.058^{a} ± 0.01 |

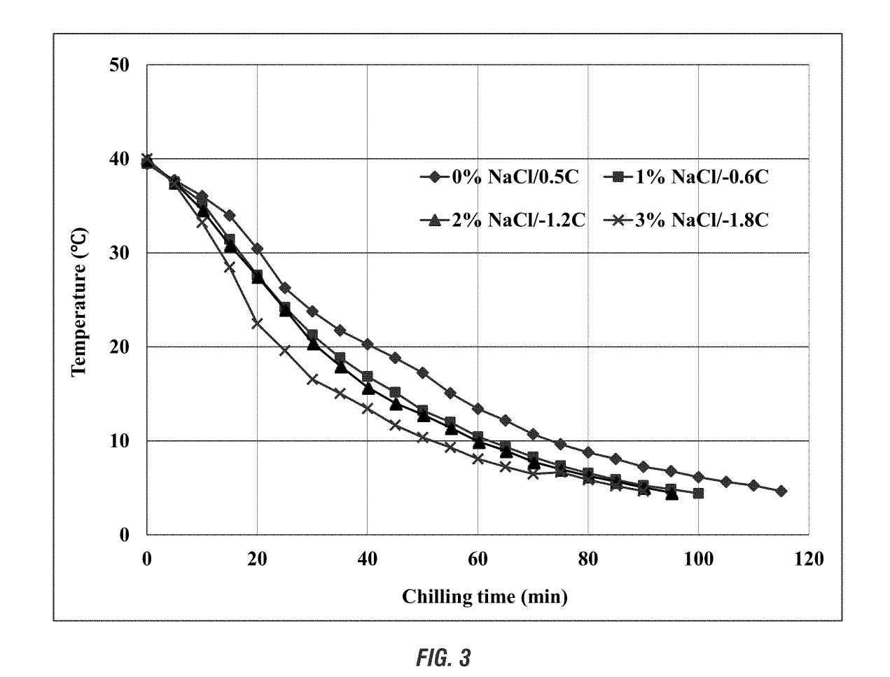

^{a}Means within a row with unlike superscripts are different (P < 0.05).
¹The number of observations in each chilling, n = 12.
²Same chilling condition as in FIG. 3

pH, R-Value, and Sarcomere Length of Breast Fillets.

After chilling, breast fillets marked pH 5.8 to 6.03 with no significant differences, regardless of chilling method (P>0.05). In response to pH, no significant difference was found for R-value with the range of 1.24 to 1.29, regardless of chilling method (P>0.05) (Table 1).

In evaluation of salt content in cooked breast fillets, no significant difference was found between water chilling and brine chilling with the range from 0.056 to 0.06% (P>0.05) (Table 1). According to USDA National Nutrition Database (2016), the average amount of salt in skinless raw chicken breast is about 0.1% (45 mg sodium/100 g). The salt content of cooked fillets in our study is less than 0.01% with no significant difference between water and brine chilling. Lower salt content than the previous reports was found with rapid chilling at sub-zero chilling temperatures (−0.6 to −1.8° C. vs 1 to 21° C.) with no pre-chilling step.

The cooking yield of breast fillets ranged from 71.5 to 73.4% with no significant difference, regardless of chilling method (Table 1).

Shear Force.

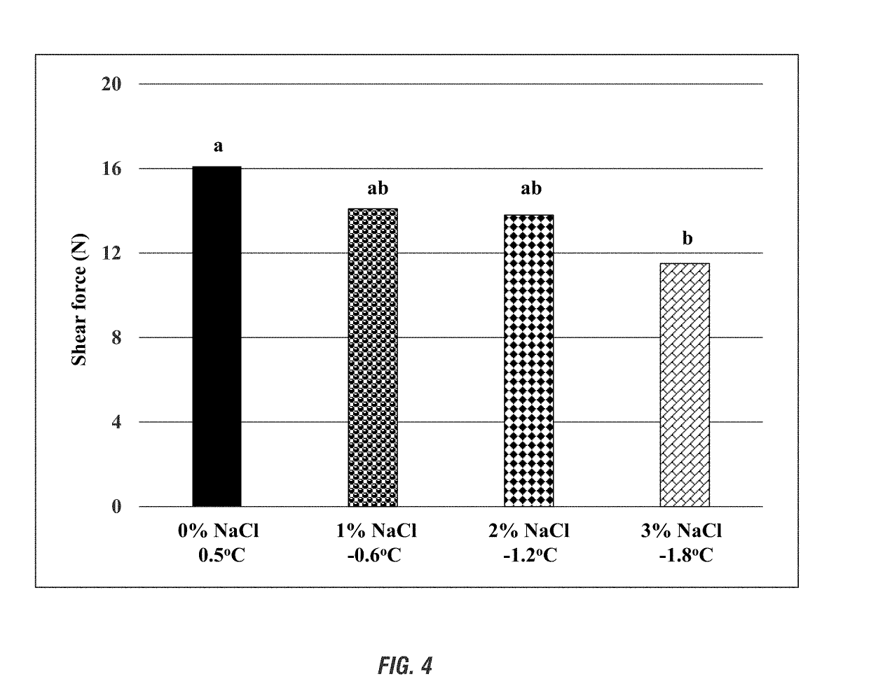

The shear force of breast fillets decreased from 16.1 to 11.5 (N) in a step wise pattern as the salt content increased from 0%/0.5° C. to 3%/−1.8° C., with the lowest shear force (tenderization) observed in 3% NaCl brine at −1.8° C. (P<0.05) (FIG. 4).

### Example IV. Carcass Chilling Using Brine Solution at 0, 3 and 4%

Broiler Carcass Chilling. A total of 48 broilers (Ross 708, approximately 45 days old) were obtained from a local broiler processing plant and used for three chilling treatments (12 birds/replication for 4 replications). Each bird was processed, weighed and tagged as before in Experiment I. Resulting carcasses were chilled, temperatures were monitored during chilling, and carcass weights were recorded after chilling as before, using one of the three chilling methods: 1) ice slurry at 0.5° C., 2) 3% salt brine solution at −1.8° C., and 3) 4% salt brine solution at −2.4° C.

Results.

Carcass chilling time. The internal temperature of eviscerated or prior-chilling carcasses was 40° C. that was continuously reduced to 4.3˜4.5° C. during chilling, with average chilling times for 90, 80, and 55 min in water control at 0% NaCl/0.5° C. and two brine solutions (3% NaCl/−1.8° C. and 4% NaCl/−2.4° C.), respectively.

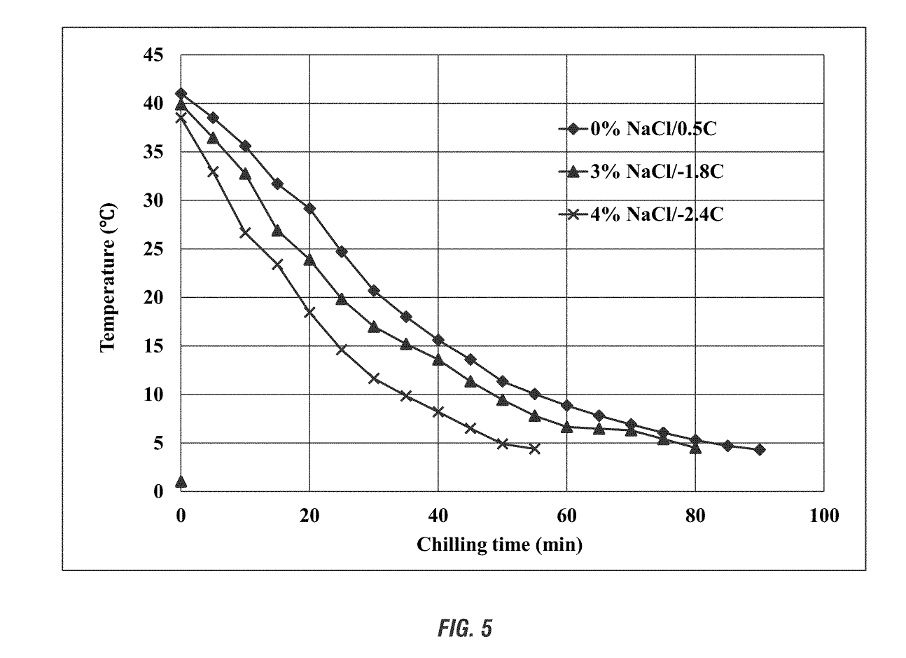

Temperature change profiles of broiler fillets during chilling in water and brine solutions are shown in FIG. 5 and reflect the following conditions:

0% NaCl/0.5° C.; carcass chilling in ice slurry (0% NaCl) at 0.5° C.

3% NaCl/−1.8° C.; carcass chilling in 3% NaCl at −1.8° C.

4% NaCl/−2.4° C.; carcass chilling in 4% NaCl at −1.8° C.

These results indicated that 4% NaCl significantly reduced the chilling time by 35 min (or 39%) compare to the water control. At the end of chilling, the surface temperature of carcasses at 2 mm depth was 2.88, −0.20, and −0.62 for the water control/0.5° C., 3% NaCl/−1.8° C., and 4% NaCl/−2.4° C., respectively.

Shear Force

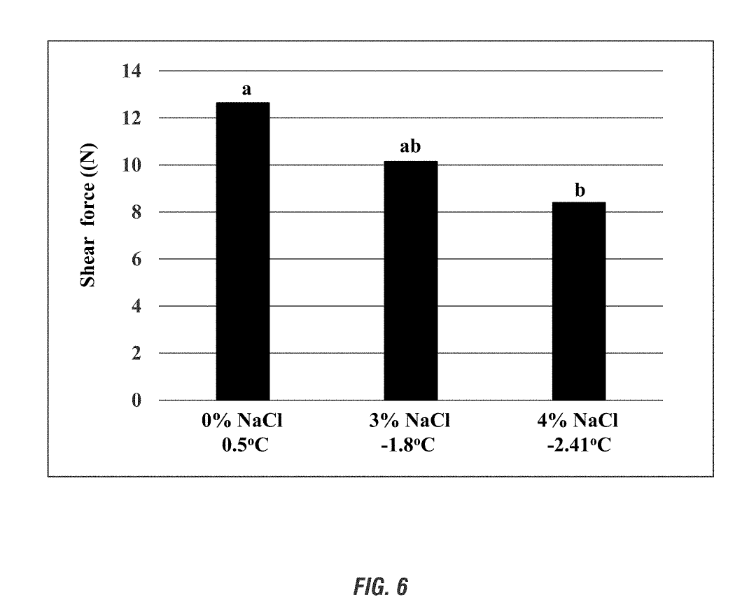

The shear force of fillets significantly decreased from 12.6 to 8.4 (N) as the salt content increased and temperature decreased from 0%/0.5° C. to 4% NaCl/−2.41° C. (P<0.05), with the intermediate value (tenderization) observed in 3% NaCl brine at −1.8° C. (FIG. 6). When animal is slaughtered, the animal carcass becomes stiffen as rigor mortis develops, influencing fresh muscle quality and further processed product value (Wakefield et al., 1989; Dunn et al., 1993a). When an individual muscle is detached (hot deboned), the hot-cut muscle is more vulnerable to either rigor shortening (heat shortening) at ≥10° C./pH≤6.20 and/or cold shortening at ≤0.5° C./pH≥6.70 (Dunn et al., 1993b,c) due to no bone attachment. Bilgili et al (1989) placed eviscerated broilers into four postmortem aging temperatures at 41, 28, 14, and 0° C. for 4 h. After 1 h exposure, no sarcomere length was reduced at 28 and 14° C. while significantly reduced sarcomere length was observed at 41 and 0° C. (P<0.05), indicating that rigor (heat) shortening and cold shortening occurred at 41 and 0° C., respectively. After 4 h exposure at 41, 28, 14, and 0° C. with follow up chilling for 1 h at 0° C. in ice slurry, lower shear force (more tenderization) and higher cooking yield values were seen in the carcasses at 0° C. than 41° C., with intermediate values observed at 28 and 14° C. These results indicated that rigor shortening occurred at 41° C. and negatively influence on meat tenderness and cooking yield than did cold shortening at 0° C.

When breast fillets were hot-boned and placed at three incubation temperatures, rigor development was completed in 5.5, 4.5, and 0.8 h at 0, 23, and 41° C., respectively (Papinaho and Fletcher, 1996). These results indicated that rigor shortening (or muscle toughening) can occur at the early stage of exposure at 41° C., whereas cold shortening can occur in the late stage of exposure at 0° C. due to the time required for the carcass to chill to 4.4° C. or lower.

In our study, the temperature of broiler carcasses was reduced from 40±1° C. to 20° C. in 30, 25, and 17 min and from 20° C. to 4.4±1° C. in 60, 55, and 38 min during chilling in 0%/0.5° C., 3% NaCl/−1.8° C., 4% NaCl/−2.41° C. solutions, respectively. As a result, it is presumed that the combined time of rigor and cold shortening would be 90, 80, and 55 min for the carcasses in the three chilling solutions, respectively, indicating that carcasses in sub-zero temperature solutions were in shorter rigor and cold shortening times than the control carcasses (FIG. 5). It is reported that rigor shorten (heat shortening) in bovine muscle occurred at 20° C. and above while cold shortening occurred at the temperatures lower than 20° C. (Locker and Hagyard, 1963; Marsh and Leet, 1966; Honikel et al., 1983).

In our study, the sarcomere length of breast fillets in sub-zero saline chilling was significantly longer and more tenderized than control chilling at 0% NaCl/0.5% (P<0.05), regardless of post mortem time (P<0.05) (Table 2; FIG. 6). These results were found with the shorter exposure to rigor and cold shortening temperatures. Similarly, Dunn et al. (2000) reported that sarcomere lengths of fast-air-chilled fillets at −12° C. were longer than those of slow-air-chilled fillets at 0° C., with almost no rigor shortening (hot shortening) found at −12° C.

During the chilling and post-chill storage to 3 h postmortem, the fillet pH reduced to 5.8 to 5.94 with no significant difference, regardless of chilling methods (P>0.05). During post-chill aging, the pH of control fillets significantly reduced from 5.94 at 3 h postmortem to 5.77 (P<0.1) at 24 h postmortem whereas the pH of saline solution fillets remained same (Table 2). R-value (an indicator of adenosine triphosphate depletion) in control fillets was lower (1.12) than sub-zero chilling fillets (1.38-1.40) (P<0.05). The higher R-values in sub-zero chilling fillets were expected due to the longer post-chilling storage at 4.5° C. (100 to 125 min) than the control fillets (90 min) to meet the 3 h postmortem time. These results are similar to the report of previous research (Sansawat, et al., 2014). Table 2 is a Table showing pH, R-value and sarcomere length of broiler fillets after chilling in water or brine solutions.

TABLE 2
Evaluation¹ of pH, R-value, sarcomere length (±SEM) after chilling carcasses² in three
different chilling solutions.

| | 3 h post mortem | | | 24 h post mortem | | |
|---|---|---|---|---|---|---|
| chilling | 0% NaCl/0.5° C. | 3% NaCl/−1.8° C. | 4% NaCl/−2.4° C. | 0% NaCl/0.5° C. | 3% NaCl/−1.8° C. | 4% NaCl/−2.4° C. |
| pH | 5.94 ± 0.09 | 5.80 ± 0.06 | 5.80 ± 0.13 | 5.77* ± 0.00 | 5.80 ± 0.07 | 5.81 ± 0.14 |
| R-value | 1.12^{b} ± 0.10 | 1.38^{a} ± 0.03 | 1.40^{a} ± 0.06 | 1.44^{a} ± 0.04 | 1.43^{a} ± 0.06 | 1.43^{a} ± 0.05 |
| Sarcomere | 1.57^{b} ± 0.16 | 1.9^{bc} ± 0.03 | 2.02^{ab} ± 0.04 | 1.74^{cd} ± 0.13 | 2.04^{ab} ± 0.06 | 2.21^{a} ± 0.02 |
| Length (μm) | | | | | | |

*Dumett's t-test (pH) between 0% NaCl/0.5° C. and other treatments (P < 0.1).
^{a-d}Means (R-value and sarcomere length) within a row with unlike superscripts are different (P < 0.05).
¹The number of observations in each chilling, n = 4.
²Same chilling conditions as in FIG. 5.

Reduction of Bacterial Populations.

Live birds at the farm level are known carriers and fecal shedders of Salmonella, Escherichia coli (E. coli), and Campylobacter spp., which can easily contaminate other clean carcasses and equipment in processing plants. During carcass washing and chilling, various chemicals are currently used to minimize poultry carcass contamination, including chlorine, trisodium phosphate, ozone, and organic acids. However, the incidence of human foodborne illness from Salmonella in 2012 has been remained unchanged compared with 206-2008, and Campylobacter, following Salmonella, is the second most commonly identified source of bacterial foodborne illness in the United States (FoodNet 2012; Scallan et al., 2011).

Most disease-causing bacteria do not grow well at 10 percent sodium chloride concentration or below a water activity (Aw) of 0.94, although most mold and halophilic bacteria can grow with no issues under the low Aw conditions. At certain Aw levels, bacteria are capable of growth but not of producing toxins. For example, Staphylococcus aureus can grow at 37° C. at an Aw of 0.86, but only produces enterotoxin if Aw is at least 0.90 or higher (Baird-Parker, 1990). In the broth culture at pH 6/10° C., salt significantly increased the time required for one generation of growth from 5 h at 0.5% salt to 20-27 h at 9.5% salt for some pathogens including E. coli, Salmonella spp. and nonproteolytic Clostridium botulinum (Dole and Glass, 2010).

In our study, unchilled broiler skin showed the populations of mesophilic aerobic bacteria (MAB), E. coli, and total coliforms for 3.81, 0.78, and 1.86 (log cfu/g), respectively. Those bacterial cells were significantly reduced after chilling in sub-zero saline than in ice slurry control for MAB at 4% NaCl/−2.41° C. and for E. coli/total coliforms at 3% NaCl/−1.8° C. (P<0.05). (Table 3). Most disease-causing bacteria do not grow well at 10 percent sodium chloride concentration or below an Aw of 0.94, although most mold and halophilic bacteria can grow with no issues under the low Aw conditions.

In the broth culture at pH 6/10° C., a high salt content (5.5%) was required to prolong generation time of Listeria. monocytogenes to 11 h, where the combination of low salt content (3%) and 100 ppm nitrite showed approximately the same growth inhibitory effects (Dole and Glass, 2010). Salt addition (3-15%) to chilling water may not be sufficient to completely inhibit growth of pathogens. However, salt addition of 3-4% to chilling solutions at subzero temperatures may reduce the bacterial activity and skin attachment than 0% NaCl at above zero temperatures. In addition, the salt may collaboratively work with other preservatives such as chlorine and para acetic acid to bring synergistic effects. Table 3 is a Table showing populations of mesophilic aerobic bacteria (MAB), Escherichia coli (E. coli) and total coliforms on broiler skin after chilling in water or brine solutions.

TABLE 3
Mean population¹ (log cfu/g) (SD) of mesophilic aerobic bacteria (MAB), Escherichia.
coli, (E. coli) and total coliforms on broiler skin after chilling.

| | Before chilling | After chilling | | | | | |
|---|---|---|---|---|---|---|---|
| | None | 0% NaCl/0.5° C. | | 3% NaCl/−1.8° C. | | 4% NaCl/−2.4° C. | |
| MAB | 3.81^{a} (0.09) | 3.62^{ab} | (0.13) | 3.49^{ab} | (0.14) | 3.34^{b} | (0.15) |
| E. coli | 0.78^{a} (0.20) | 0.60^{a} | (0.13) | 0.02^{c} | (0.02) | 0.23^{bc} | (0.09) |
| Total coliforms | 1.86^{a} (0.12) | 1.34^{b} | (0.15) | 0.37^{c} | (0.12) | 0.63^{c} | (0.13) |

^{a-c}Means within a row with no common superscripts are different (P < 0.05).
¹Number of observation, n = 4

### Example V: Turkey Carcass Chilling Using Brine Solution at 0, 4, and 8%

Turkey carcass chilling. A total of 12 tom turkeys (Nicholas, approximately 45 days old) were used for three chilling treatments (2 birds/treatment for two replications), using one control (0% NaCl/0.5° C.) and two sub-zero (4% NaCl/−2.41° C. and 8% NaCl/−5.08° C.) solutions. Eviscerated turkey carcasses were randomly picked from the processing line in a local processing plant and subjected to one of the three chilling solutions to chill as similar as the carcasses in Example III.

Results.

Carcass Chilling Time. Carcass Chilling Time.

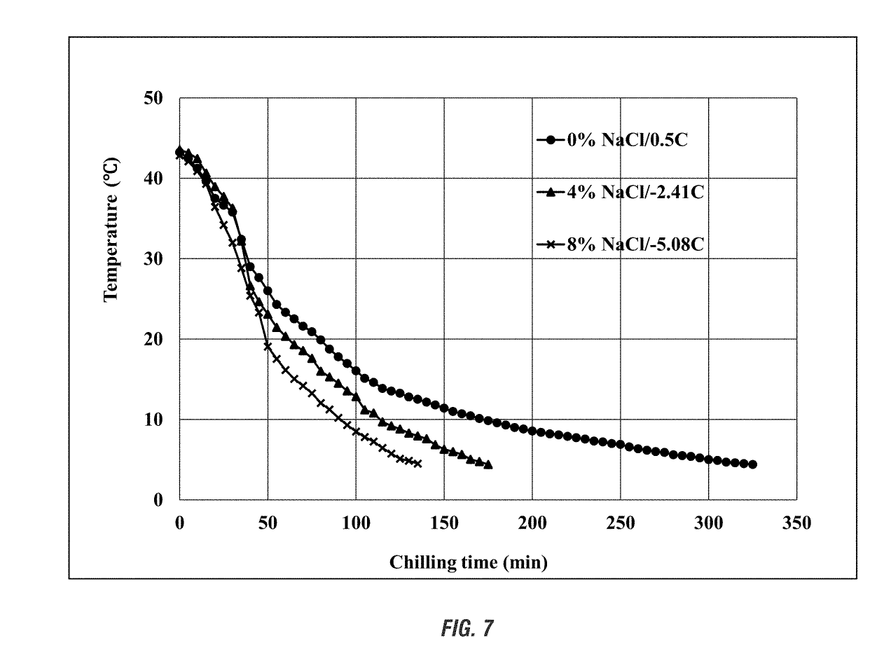

The internal temperature of eviscerated carcasses was ˜43° C. that was continuously reduced to ˜4.4° C., with an average chilling times for 325, 175, and 135 min in 0% NaCl/0.5° C., 4% NaCl/−2.41° C. and 8% NaCl/−5.08° C. solutions, respectively (FIG. 7). These results indicated that 8 and 4% NaCl significantly reduced the chilling time by 58% (190 min) and 46% (150 min), respectively, compare to the water control solution.

Carcass Chilling Yield and Fillet Cooking Yield. Carcass Chilling Yield and Fillet Cooking Yield.

Table 4 is a Table showing chilling yield of turkey carcass after chilling in water or brine solutions, and cooking yield of turkey fillet after cooking. After chilling, the weight gain of turkey carcasses showed 101.4, 108.1, and 102.8 for 0% NaCl/0.5° C., 4% NaCl/−2.41° C. and 8% NaCl/−5.08° C., respectively. After cooking, the cooking yield of turkey fillets was 75.6, 73.5 and 72.0 for the three chilling methods (Table 4).

TABLE 4
Measurement (%)¹ of carcass chilling² yield and fillet cooking
yield (±SEM) after chilling carcasses in three different methods

| Chilling | 0% NaCl/0.5° C. | 4% NaCl/−2.4° C. | 8% NaCl/−5.08° C. |
|---|---|---|---|
| Chilling yield (%) | 101.4 ± 2.0 | 108.1 ± 7.8 | 102.8 ± 3.9 |
| Cooking yield (%) | 75.6 ± 1.36 | 73.5^{a} ± 0.42 | 72.0 ± 2.41 |

¹The number of observations in each chilling, n = 4.

Reduction of Bacterial Populations.

After chilling, the populations of Escherichia coli (E. coli) and total coliforms on carcasses in subzero saline solutions were significantly reduced more than the carcasses in control solution, regardless of salt concentration (P<0.05). The populations of mesophilic aerobic bacteria (MAB) showed a similar pattern of bacterial reduction in 4% NaCl/−2.41° C. more than 0% NaCl/0.5° C., with in intermediate reduction seen in 8% NaCl/−5.08° C. (Table 5). Table 5 is a Table showing populations of mesophilic aerobic bacteria (MAB), Escherichia coli (E. coli) and total coliforms on turkey skin after chilling in water or brine solutions.

TABLE 5
Mean population¹ (log cfu/g) (SD) of mesophilic aerobic bacteria (MAB), Escherichia.
coli, (E. coli) and total coliforms on turkey skin after chilling.

| | After chilling | | | |
|---|---|---|---|---|
| | 0% NaCl/0.5° C. | 4% NaCl/−2.4° C. | 8% NaCl/−5.08° C. | |
| MAB | 4.70^{a} (0.84) | 3.34^{b} (0.07) | 3.68^{ab} | (0.11) |
| E. coli | 2.09^{a} (0.33) | 0.15^{b} (0.29) | <0.01^{b} | (<0.01) |
| Total coliforms | 1.65^{a} (0.64) | 0.15^{b} (0.29) | <0.01^{b} | (<0.01) |

^{a-b}Means within a row with no common superscripts are different (P < 0.05).
¹Number of observation, n = 4

### REFERENCES

Alvarado, C. Z., and A. R. Sams. 2002. The role of carcass chilling rate in the development of pale, exudative turkey pectoralis. Poult. Sci. 81:1365-1370.
Baertlein and Huffstutter. 2015. Drought woes in California town highlight thirsty poultry industry. Reuters. October http://www.reuters.com/article/us-usa-drought-fosterfarms-insight-idUSKCN0RW0A620151002.
Baird-Parker A. C. 1990. The staphylococci: An introduction. J. Appl Bactriol 61:3121-3123.
Bilgili, S. F., W. R. Egbert, and D. L. Huffman. 1989. Effect of postmortem aging temperature on sarcomere length and tenderness of broiler Pectoralis major. Poult. Sci. 68:1588-1591.
California Department of Food and Agriculture. 2015. California Agricultural Statistics Review 2014-2015. https://www.cdfa.ca.gov/statistics/PDFs/2015Report.pdf
California Poultry Federation. 2007. Poultry Statistics. http://cpif org/poultry-statistics
Carroll, C. D., and C. Z. Alvarado. 2008. Comparison of air immersion chilling on meat quality and shelf life of marinated broiler breast fillets. Poult. Sci. 87:368-372.
Cavitt, L. C., Youm, G. W., Meullenet, J. F., Owens, C. M. and Xiong, R. 2004. Prediction of poultry meat tenderness using razor blade shear, Allo-Kramer shear, and sarcomere length. Journal of Food Science, 69(1): SNQ11-SNQ15.
CDC (Center for Disease Control and Prevention). FoodNet Report. 2012. Accessed on June 7 2015 from http://www.cdc.gov/foodnet/PDFs/2012_annual_report_508c.pdf
Cross, H. R., West, R. L. and Dutson, T. R. 1981. Comparison of methods for measuring sarcomere length in beef semitendinosus muscle. Meat science, 5(4):261-266.
Dole M. E. and K. A. Glass. 2010. Sodium reduction and its effect on food safety, food quality, and human health. Comprehensive Reviews in Food Science and Food Safety. 9:44-56.
Dunn, A. A., Kilpatrick, D. J. and Gault, N. F. S. 1993a. Influence of ultimate pH, sarcomere length and cooking loss on the textural variability of cooked M. pectoralis major from free range and standard broilers. Br. Poult. Sci. 34:663-675.
Dunn, A. A., Kilpatrick, D. J. and Gault, N. F. S. 1993b. Effect of post-mortem temperature on chicken M. pectoralis major: Muscle shortening and cooked meat tenderness. Br. Poult. Sci. 34:689-697.
Dunn, A. A., Kilpatrick, D. J. and Gault, N. F. S., 1995. Contribution of rigor shortening and cold shortening to variability in the texture of Pectoralis major muscle from commercially-processed broilers. British Poultry Science, 36(3): 401-413.
Dunn, A. A., Tolland, E. L. C. Kilpatrick, D. J. and Gault, N. F. S. 1993c. Effect of post-mortem temperature on chicken M. pectoralis major: Isometric tension and pH profiles. Br. Poult. Sci. 34:677-688.
Dunn, A. A., C. Tolland, E. L., Kilpatrick, D. J. and Gault, N. F. S., 2000. Relationship between early post-mortem muscle pH and shortening-induced toughness in the Pectoralis major muscle of processed broilers air-chilled at 0° C. and −12° C. British poultry science, 41(1): 53-60.
Fletcher, D. L. 2002. Poultry meat quality. World's Poultry Science J. 58:131-145.
Hirschler, E. M. and Sams, A. R. 1998. Commercial-scale electrical stimulation of poultry: the effects on tenderness, breast meat yield, and production costs. J. Appl. Poult. Res. 7: 99-103.
Honikel, K. O., P. Roncales, and R. Hamm, 1983. The influence of temperature on shortening and rigor onset in beef muscle. Meat Sci. 8:221-241.
Jeong, J. Y., K. K. Janardhanan, A. M. Booren, J. B. Harte, and I. Kang. 2011a. Breast meat quality and consumer sensory properties of broiler carcasses chilled by water, air, or evaporative air. Poult. Sci. 90:694-700.
Jeong, J. Y., K. K. Janardhanan, A. M. Booren, D. M. Karcher, and I. Kang. 2011b. Moisture content, processing yield, and surface color of broiler carcasses chilled by water, air, or evaporative air. Poult. Sci. 90:687-693.
Lee, H. C., M. Medellin-Lopez, P. Singh, T. Sansawat, K. B. Chin, and I. Kang. 2014. cold-batter mincing of hot-boned and crust-frozen air-chilled turkey breast allows for reduced sodium content in protein gels. Poult. Sci. 93:2327-2336.
Locker, R. H., and C. J. Hagyard, 1963. A cold shortening effect in beef muscle. J. Sci. Food Agric. 14:787-793.
Marsh, B. B., and N. G. Leet, 1966. Studies on meat tenderness. 3. The effects of cold shortening on tenderness. J. Food Sci. 33:450-458.
McKee, S. R., and A. R. Sams. 1998. Rigor mortis development at elevated temperatures induces pale exudative turkey meat characteristics. Poult. Sci. 77:169-174.
Navarri, P., Bédard, S., Klemeš, J., Smith, R. and Kim, J. K. 2008. Auditing energy and water use in the food industry. Handbook of water and energy management in food processing: 85-112.
North Carolina Division of Environment and Natural Resources. 2010. Water and Wastewater Use in the Food Processing Industry—Meat and Poultry Processing. http://www.nwfpa.org/nwfpa.info/component/content/article/372-water-and-wastewater-use-in-the-food-processing-industry?start=2.
Papinano, P. A. and Fletcher D. L. 1996. The influence of temperature on broiler breast muscle shortening and extensibility. Poult. Sci. 75:797-802.
Pederson, R. 1979. Advantages and disadvantages of various methods for the chilling of poultry. Rep. No. 189. Landbrugsministeriets Slagteri-og Konserveslaboratorium, Copenhagen, Denmark.
Sams, A. 1999. Commercial implementation of postmortem electrical stimulation. Poult. Sci. 78:290-294.
Sams, A. 2002. Post-mortem electrical stimulation of broilers. Word's Poult. Sci. J. 58:147-157.
Sams, A. R., and D. M. Janky. 1986. The influence of brine chilling on tenderness of hot-boned, chilled-boned, and age-boned broiler fillets. Poult. Sci. 65:1316-1321.
Sansawat, T., H. C. Lee, P. Singh, H. Kim, K. B. Chin, and I. Kang. 2014. Combination of muscle tension and crust-freeze-air-chilling improved efficacy of air chilling and quality of broiler fillets. Poult. Sci. 93:2314-2319.
Saravia, H., Houston, J. E., Toledo, R. T. and Nelson, H. M. 2005. Economic analysis of recycling chiller water in poultry-processing plants using ultrafiltration membrane systems. Journal of Food Distribution Research, 36(1): 161-166.
SAS Institute. 2002. SAS User's Guide. SAS Inst. Inc., Cary, N. C.
Scallan, E., R. M. Hoekstra, F. J. Angulo, R. V. Tauxe, M. A. Widdowson, S. L. Roy, J. L. Jones, and P. M. Griffin. 2011. “Foodborne Illness Acquired in the United States—Major Pathogens,” Emerging Infectious Disease 17(1): 7-15.
Selmer R M, Kristiansen I S, Haglerød A, Graff-Iversen S, Larsen H K, Meyer H E, Bønaa K H, Thelle D S, 2000. Cost and health consequences of reducing the population intake of salt. Journal of Epidemiology and Community Health, 54, 697-702.
Thompson, L. D., D. M. Janky, and S. A. Woodward. 1987. Tenderness and physical characteristics of broiler breast fillets harvested at various times from post-mortem electrically stimulated carcasses. Poult. Sci. 66:1158-1167.
Uijttenboogaart, T. G. 2007. Electrical stimulation of poultry. Proceedings of 11^{th} European Poultry Conference.
USDA-Food Safety and Inspection Service. 2001. Cooking for Groups: A Volunteer's Guide to Food Safety. USDA-Food Safety and Inspection Service, Washington, D.C.
USDA National Nutrient Database for Standard Reference (2016). Sodium content in skinless chicken breast.
Wakefield, D, K., E. Dransfield, N. F. Dawn, and A. A. Taylor. 1989. Influence of post-mortem treatments on turkey and chicken meat texture. Int. J. Food Sci. Technol. 24:81-92.

What is claimed is:

1. A method of producing a meat product comprising
a) chilling said carcass by immersing an animal carcass in at least one salt water solution comprising about 1% to 10% salt weight per volume (w/v);
b) maintaining said solution at a temperature of about −0.6° C. to −6.0° C.; and
c) producing a meat product that has 1% or less salt content difference compared to salt content of said carcass that was immersed in water solution.

2. The method of claim 1, wherein said meat product does not have increased salt content after immersion in said water.

3. The method of claim 1, wherein said carcass is immersed in said water until the temperature of said carcass is about 5° C. or less.

4. The method of claim 1, wherein said carcass is immersed in said water until the temperature of said carcass is 4.0° C. to 5° C.

5. The method of claim 1, wherein said carcass is immersed in said water until the temperature of said carcass is 4.3° C. to 4.5° C.

6. The method of claim 1, wherein said carcass is immersed in said water for up to 2 hours.

7. The method of claim 1, further comprising pre-chilling said carcass prior to immersing said carcass in said salt water solution.

8. The method of claim 7, wherein said pre-chilling step comprises immersing said carcass in at least one water solution not comprising salt at a temperature of about 5° C. to 20° C.

9. The method of claim 8, wherein said carcass is pre-chilled for up to 30 minutes.

10. The method of claim 7, wherein said pre-chilling comprises immersing said carcass in at least one water solution wherein said at least one water solution does not comprise salt.

11. The method of claim 1, further comprising post-chilling said meat product at about 1° C. to 5° C.

12. The method of claim 1, wherein said solution comprises 3% salt w/v.

13. The method of claim 1, wherein said solution comprises 4% salt w/v.

14. The method of claim 1, wherein said solution is held at a temperature of −1.0° C. to −4.0° C. and comprises 3% to 4% salt w/v.

15. The method of claim 1, wherein said solution is held at a temperature of −2.0° C. to −3.0° C. and comprises 3% salt w/v.

16. The method of claim 1, wherein said meat product has reduced shear force compared to a meat product immersed in a water solution not comprising salt and not held at said temperature.

17. A method of reducing cost of producing a meat product, the method comprising,
a) chilling said carcass by immersing an animal carcass in at least one salt water solution comprising about 1% to 10% salt weight per volume (w/v);
b) maintaining said solution at a temperature of about −0.6° C. to −6° C.; and
c) reducing cost of producing said meat product by a method selected from
(i) reducing the amount of time for chilling said carcass;
(ii) reducing potable water used during said chilling; or
(iii) reducing the amount of waste water output produced by said chilling,
compared to a process for chilling said carcass that immerses said carcass in a water solution that does not comprise salt and is not held at said temperature.

18. The method of claim 17, wherein said method reduced the amount of time for chilling said carcass by up to 60%.

19. The method of claim 17, wherein said method reduced the amount of time for chilling said carcass by up to 20% to 60%.

20. A method of reducing bacteria population of a meat product, the method comprising,
a) chilling said carcass by immersing an animal carcass in at least one salt water solution comprising about 1% to 10% salt weight per volume (w/v);
b) maintaining said solution at a temperature of about −0.6° C. to −6° C.; and
c) reducing bacteria population of said meat product compared to a process for chilling said carcass that immerses said carcass in a water solution that does not comprise salt and is not held at said temperature.
